(19) United States
(12) Patent Application Publication
(10) Pub. No.: US 2025/0259998 A1
(43) Pub. Date: Aug. 14, 2025

(54) CATHODE ACTIVE MATERIAL WITH A CORE/SHELL STRUCTURE INCLUDING LMR AND NMX CATHODE ACTIVE MATERIALS

(71) Applicant: GM GLOBAL TECHNOLOGY OPERATIONS LLC, Detroit, MI (US)

(72) Inventors: Gongshin QI, Troy, MI (US); Lei WANG, Rochester Hills, MI (US); Devendrasinh DARBAR, Stering Heights, MI (US); Sayed Youssef Sayed NAGY, Troy, MI (US); Meng JIANG, Rochester Hills, MI (US)

(21) Appl. No.: 18/439,903

(22) Filed: Feb. 13, 2024

(51) Int. Cl. H01M 4/36; C01G 53/00; H01M 4/02; H01M 4/04; H01M 4/131; H01M 4/1391; H01M 4/505; H01M 4/525

(52) U.S. Cl. CPC H01M 4/366; C01G 53/50; C01G 53/66; C01G 53/70; H01M 4/0404; H01M 4/131; H01M 4/1391; H01M 4/505; H01M 4/525; C01P 2002/50; C01P 2004/84; C01P 2006/40; H01M 2004/028

(57) ABSTRACT

A method for manufacturing a cathode electrode includes forming a composite cathode active material by providing a first cathode active material. The first cathode active material comprises a lithium- and manganese-rich (LMR) cathode active material. The method includes forming an outer layer including a second cathode active material on the first cathode active material to form a composite cathode active material. The second cathode active material comprises an NMX cathode active material including lithium, and nickel and manganese with a molar ratio in a range from 3/7 to 8/2.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to cathode active material with a core/shell structure including LMR and NMX cathode active materials, respectively.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing a cathode electrode includes forming a composite cathode active material by providing a first cathode active material. The first cathode active material comprises a lithium- and manganese-rich (LMR) cathode active material. The method includes forming an outer layer including a second cathode active material on the first cathode active material to form a composite cathode active material. The second cathode active material comprises an NMX cathode active material including lithium, and nickel and manganese with a molar ratio in a range from 3/7 to 8/2.

In other features, the second cathode active material is cobalt-free. The first cathode active material comprises Li₁₊ₐNi_{b}Mn_{c}M_{d}O₂, where a+b+c+d=1.0, a is in a range from 0.05 to 0.3, M_{d} is a metal, b is in a range from 0.1 to 0.5, c is in a range from 0.2 to 0.8, and d is in a range from 0.01 to 0.2. The metal M_{d} is selected from a group consisting of iron, titanium, cerium, tungsten, molybdenum, vanadium, zirconium, niobium, tantalum, aluminum, cobalt, and magnesium.

In other features, the second cathode active material comprises LiNiₓMn_{y}M_{z}O₂, where x+y+z=1.0, M_{z} is a metal, x is in a range from 0.4 to 0.8, y is in a range from 0.2 to 0.6, and z is in a range from 0.01 to 0.2. The metal M_{z} is selected from a group consisting of iron, tungsten, molybdenum, vanadium, zirconium, niobium, aluminum, magnesium, and tantalum. A weight ratio of the second cathode active material to the first cathode active material is in a range from 0.1 to 1.0.

In other features, the method includes creating a mixture including the composite cathode active material, a conductive filler, and a binder; and applying the mixture onto a cathode current collector to form a cathode active material layer of the cathode electrode.

In other features, the cathode active material layer comprises the composite cathode active material in a range from 90 wt % to 98 wt %, a conductive filler in a range from 0.5 wt % to 10 wt %, and a binder in a range from 0.5 wt % to 10 wt %.

In other features, the outer layer is formed on the first cathode active material using co-precipitation. The outer layer is formed on the first cathode active material using spray drying. The outer layer is formed on the first cathode active material using dry mixing.

A cathode electrode includes a cathode current collector and a cathode active material layer including a composite cathode active material comprising a first cathode active material and an outer layer including a second cathode active material arranged on the first cathode active material. The first cathode active material comprises a lithium- and manganese-rich (LMR) cathode active material, and the second cathode active material comprises an NMX cathode active material including lithium, and nickel (Ni) and manganese (Mn) with a molar ratio in a range from 3/7 to 8/2.

In other features, the first cathode active material comprises Li₁₊ₐNi_{b}Mn_{c}M_{d}O₂, where a+b+c+d=1.0, a is in a range from 0.05 to 0.3, M_{d} is a metal, b is in a range from 0.1 to 0.5, c is in a range from 0.2 to 0.8, and d is in a range from 0.01 to 0.2. The metal M_{d} is selected from a group consisting of iron, titanium, cerium, tungsten, molybdenum, vanadium, zirconium, niobium, tantalum, aluminum, cobalt, and magnesium.

In other features, the second cathode active material comprises LiNiₓMn_{y}M_{z}O₂, where x+y+z=1.0, M_{z} is a metal, x is in a range from 0.4 to 0.8, y is in a range from 0.2 to 0.6, and z is in a range from 0.01 to 0.2. The metal M_{z} is a metal selected from a group consisting of iron, tungsten, molybdenum, vanadium, zirconium, niobium, aluminum, magnesium, and tantalum.

A weight ratio of the second cathode active material to the first cathode active material is in a range from 0.1 to 1.0.

In other features, the cathode active material layer comprises the composite cathode active material in a range from 90 wt % to 98 wt %, a conductive filler in a range from 0.5 wt % to 10 wt %, and a binder in a range from 0.5 wt % to 10 wt %.

A battery cell includes C of the cathode electrode, A anode electrodes, and S separators, where C, A and S are integers greater than 1. The A anode electrodes include anode active material selected from a group consisting of Si, Si—C, SiOx, graphite, Li metal, and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross section of an example of a battery cell including cathode electrodes, anode electrodes, and separators arranged in an enclosure according to the present disclosure;

FIG. 2A is a side cross section of an example of a cathode electrode including a core comprising LMR cathode active material that is coated with an outer layer or shell including NMX cathode active material according to the present disclosure;

FIG. 2B is a side cross section of an example of a core comprising LMR cathode active material that is coated with NMX cathode active material according to the present disclosure;

FIG. 3 illustrates coating of an example of the LMR core using NMX cathode active material according to the present disclosure; and

FIGS. 4 to 6 are flowcharts of examples of methods for manufacturing NMX-coated LMR particles according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Cobalt-free, lithium- and manganese-rich (LMR) cathode active materials (e.g., with Mn>50%) operate at high operating voltages (>3.5 V vs. Li/Li+) and have high reversible specific capacities (>200 mAh/g). However, the practical application of Li-rich cathodes in Li-ion batteries is challenging.

LMR-based battery cells typically require a high amount of fluorinated electrolyte solvent (e.g., fluoroethylene carbonate (FEC)) rather than ethylene carbonate (EC). Oxidative decomposition of electrolyte and additives on the surface of LMR materials operating at high voltage levels causes gas formation and/or performance decay.

Cobalt-free, nickel and manganese layered cathode materials (NMX) typically include 50% to 80% Ni and 20% to 50% Mn. NMX cathode active materials have improved cycling stability but a lower specific capacity (e.g., 160 to 180 mAh/g) as compared to the LMR cathode active materials.

The present disclosure relates to a core-shell structured composite cathode material including LMR as the core and NMX as the shell. This cathode active material takes advantage of the properties of each cathode active material and optimizes the performance of the battery cell while minimizing the degradation of the LMR cathode caused by electrolyte/additives consumption/oxidation.

The core-shell structured composite cathode material can be cycled in an operating voltage range from 2.0V to 4.4V. Potentially, this composite cathode material can use the conventional electrolyte solvents (or less fluorinated electrolyte solvents and additives than LMR-only cathode active material).

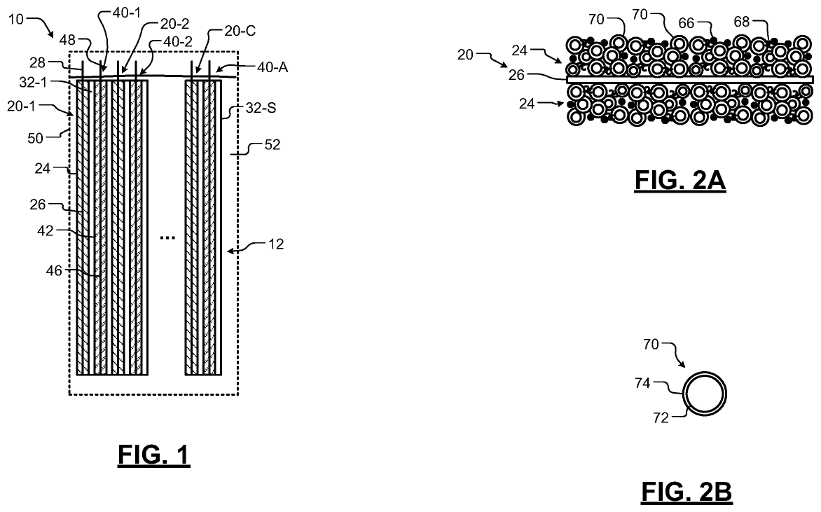

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46. During charging/discharging, the A anode electrodes 40 and the C cathode electrodes 20 exchange lithium ions.

Methods for manufacturing the cathode and/or anode electrodes include wet coating, dry coating, semi-dry coating, and/or 3D printing. In some examples, the cathode active material layers 24 and/or the anode active material layers 42 comprise coatings including one or more active materials, one or more conductive additives, and/or one or more binder materials that are cast or applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

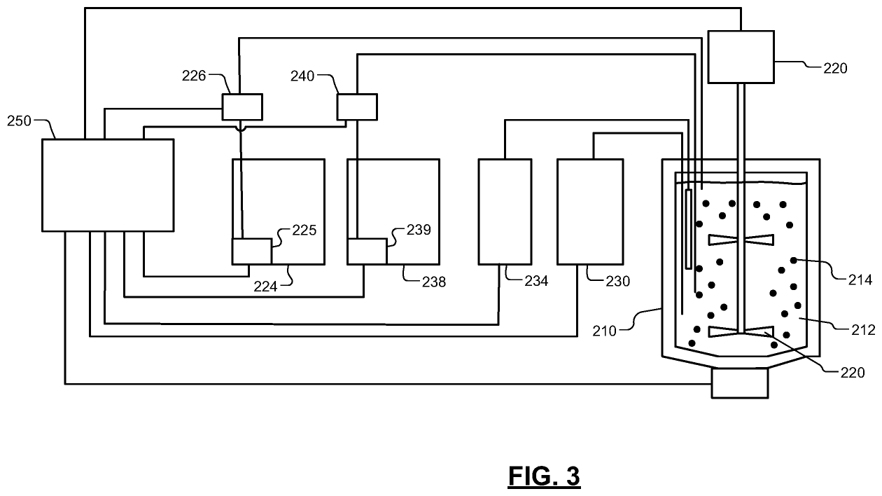

Referring now to FIGS. 2A and 2B, the cathode active material layer 24 includes composite cathode active material 70 that is mixed with the conductive additive 66 and the binder 68. In FIG. 2B, the cathode active material 70 include LMR particles 72 (or core) with an outer coating 74 (or shell) including NMX cathode active material.

In some examples, the LMR cathode active material (the core) comprises Li₁₊ₐNi_{b}Mn_{c}M_{d}O₂, where a+b+c+d=1.0; a is in a range from 0.05 to 0.3; b is in a range from 0.1 to 0.5; c is in a range from 0.2 to 0.8, and d is in a range from 0.01 to 0.2. In some examples, M_{d} is a metal selected from a group consisting of iron (Fe), titanium (Ti), cerium (Ce), tungsten (W), molybdenum (Mo), vanadium (V), zirconium (Zr), niobium (Nb), tantalum (Ta), aluminum (Al), cobalt (Co), and magnesium (Mg).

In some examples, the NMX cathode active material (the outer layer or shell) is cobalt-free and comprises LiNiₓMn_{y}M_{z}O₂, where x+y+z=1.0, x is in a range from 0.4 to 0.8; y is in a range from 0.2 to 0.6, and z is in a range from 0.01 to 0.2. M_{z} is a metal selected from a group consisting of iron (Fe), tungsten (W), molybdenum (Mo), vanadium (V), zirconium (Zr), niobium (Nb), aluminum (Al), magnesium (Mg), and tantalum (Ta). In some examples, the NMX cathode active material includes both nickel (Ni) and manganese (Mn) with a molar ratio in a range from 3/7 to 8/2.

In some examples, a weight ratio of the NMX outer layer to the LMR core is in a range from 0.1 to 1.0. In some examples, the composite cathode active material is prepared using co-precipitation, spray drying, and/or mechanical fusion. In some examples, the cathode active material layer includes cathode active material in a range from 90 wt % to 98 wt %, conductive filler in a range from 0.5 wt % to 10 wt %, and a binder in a range from 0.5 to 10 wt %. In some examples, the anode electrode includes anode active material selected from a group consisting of silicon (Si), silicon-carbide (Si—C) composite, silicon oxide (SiOx), graphite, lithium (Li) metal, and combinations thereof. In some examples, the conductive filler includes graphene nanoplatelets (GNP), carbon black (CB), carbon nanotubes (CNT), or other suitable conductive fillers. In some examples, the binder includes polytetrafluoroethylene (PTFE), polyvinylidene fluoride (PVDF), or other suitable binder.

Referring now to FIGS. 3 and 4, the NMX-coated LMR cathode active material can be produced by coprecipitation. A heated container 210 receives a mixture 212 including LMR particles 214. A mixer 220 mixes the mixture 212 at a predetermined mixing speed. A source 224 supplies NMX (e.g., in a water solution) to the heated container 210 using a valve 226 and a pump 225.

A temperature sensor 230 monitors the temperature of the mixture 212. A controller 250 adjusts heating of the heated container 210 using a heater based on the sensed temperature. A source 238 selectively supplies a hydroxide solution (e.g., sodium hydroxide and ammonia hydroxide) to the mixture 212 using a valve 240 and a pump 239. A pH controller 234 monitors the pH level of the mixture 212. The controller receives the pH level and selectively adjusts the pH level of the mixture 212 by adding the hydroxide solution to the mixture 212 using the pump 239 and the valve 240.

In some examples, the temperature of the mixture 212 is maintained at a predetermined temperature in a range from 25° C. to 80° C. In some examples, the pH level of the mixture 212 is maintained in a pH range from 7.5 to 11.5. In some examples, the reaction time for the mixture 212 is in a range from 30 minutes to 48 hrs. In some examples, the mixing speed of the mixer 220 is in a range from 700 rpm to 2000 rpm.

Referring now to FIG. 4, a method for manufacturing NMX-coated LMR particles by coprecipitation is shown. At 310, the LMR active material and water are mixed to form an LMR water slurry. At 314, the NMX and water solution is added to the LMR water slurry. The temperature and pH are monitored and controlled at 318 and 322 during coprecipitation. At 326, the NMX hydroxide-coated LMR particles are filtered, washed, and dried.

At 330, the NMX hydroxide-coated LMR particles are optionally calcinated by heating to a predetermined temperature for a predetermined period. At 334, the method includes forming a cathode electrode including a cathode active material layer (with the composite cathode active material) and a cathode current collector.

The cathode electrodes are arranged in a battery cell stack including anode electrodes and separators.

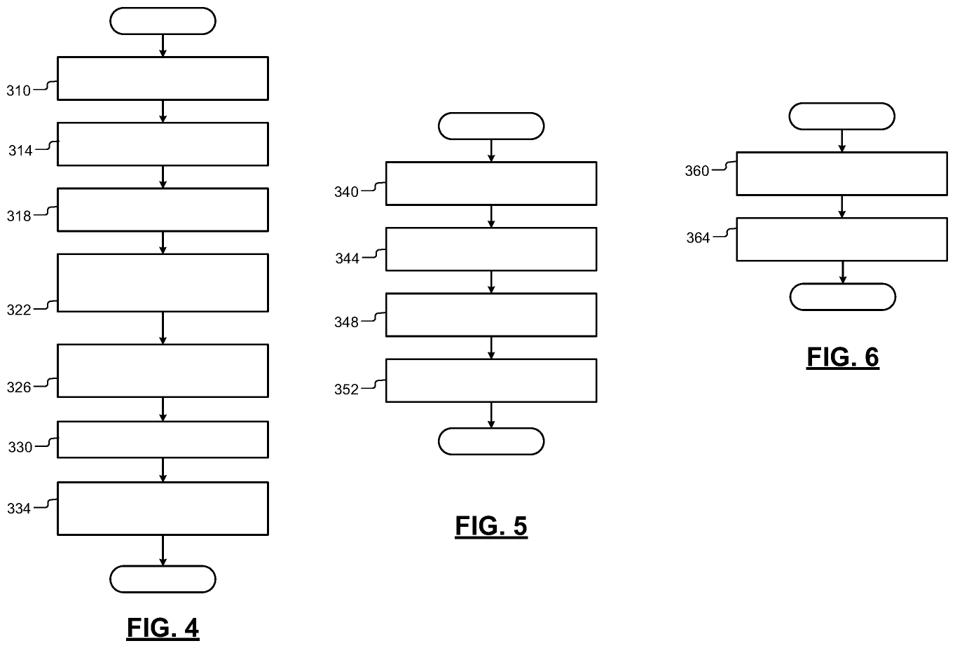

Referring now to FIG. 5, the NMX-coated LMR particles can be manufactured using spray drying. At 340, the NMX precursors are mixed with a solvent (e.g., H₂O, ethanol, acetone, isopropanol, etc.). At 344, LMR particles are added to the NMX and solvent. At 348, the LMR particles, the NMX precursors, and solvent are mixed. The mixture is spray dried at 352 and the coated particles are recovered.

In some examples, the solid content in the mixture of LMR particles, NMX, water, and solvent is in a range 1 wt % to 50 wt %. In some examples, the temperature is in a range from 50° C. to 200° C. In some examples, the pumping rate is in a range from 1% to 100%. In some examples, the atmosphere is selected from a group consisting of air, molecular nitrogen (N₂), argon (Ar), and/or helium (He).

Referring now to FIG. 6, the LMR and NMX particles are mixed together. At 364, the NMX particles are mechanically fused to the LMR particles. In some examples, the NMX particles are nano-sized (e.g., 5 nm to 1 μm) and the LMR particles are larger than the NMX particles (e.g., micron-sized (>=1 μm)). In some examples, the LMR and NMX particles are mixed using one of ball-milling, a theta composer, an electrostatic sprayer, and an acoustic mixer.

In some examples, prior to preparing the composite cathode active material, the LMR or the NMX cathode active materials can be individually formed using Mn/Ni precursors selected from a group consisting of hydroxides, carbonates, oxalates, and/or metal oxides and lithium salts selected from a group consisting of lithium carbonate Li₂CO₃, lithium nitrate (LiNO₃), lithium hydroxide (LiOH), lithium chloride (LiCl), and/or lithium fluoride (LiF), although other materials can be used.

The LMR and/or the NMX cathode active materials cathode active materials can be individually produced using a solid state reaction at a temperature in a range from 500° C. to 1200° C. in air or oxygen for a duration in a range from 1 hour to 48 hours.

In other examples, spray drying with a solvent such as water, ethanol, acetone, or isopropanol. In some examples, solid content is in a range from 1% to 50%. In some examples, a temperature is in a range from 50° C. to 200° C. In some examples, a pumping rate is in a range from 1% to 100%. In some examples, an atmosphere is air, molecular nitrogen (N₂), argon (Ar), helium, or other suitable gas.

In some examples, the LMR core and/or the NMX shell cathode active materials can be individually produced using a dry mixing process. In some examples, the LMR and NMX particles are mixed using one of ball-milling, a theta composer, an electrostatic sprayer, and an acoustic mixer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a cathode electrode, comprising:
forming a composite cathode active material by:
providing a first cathode active material,
wherein the first cathode active material comprises a lithium- and manganese-rich (LMR) cathode active material; and
forming an outer layer including a second cathode active material on the first cathode active material to form a composite cathode active material,
wherein the second cathode active material comprises an NMX cathode active material including lithium, and nickel and manganese with a molar ratio in a range from 3/7 to 8/2.

2. The method of claim 1, wherein the second cathode active material is cobalt-free.

3. The method of claim 1, wherein the first cathode active material comprises Li₁₊ₐNi_{b}Mn_{c}M_{d}O₂, where a+b+c+d=1.0, a is in a range from 0.05 to 0.3, M_{d} is a metal, b is in a range from 0.1 to 0.5, c is in a range from 0.2 to 0.8, and d is in a range from 0.01 to 0.2.

4. The method of claim 3, wherein the metal M_{d} is selected from a group consisting of iron, titanium, cerium, tungsten, molybdenum, vanadium, zirconium, niobium, tantalum, aluminum, cobalt, and magnesium.

5. The method of claim 1, wherein the second cathode active material comprises LiNiₓMn_{y}M_{z}O₂, where x+y+z=1.0, M_{z} is a metal, x is in a range from 0.4 to 0.8, y is in a range from 0.2 to 0.6, and z is in a range from 0.01 to 0.2.

6. The method of claim 5, wherein the metal M_{z} is selected from a group consisting of iron, tungsten, molybdenum, vanadium, zirconium, niobium, aluminum, magnesium, and tantalum.

7. The method of claim 1, wherein a weight ratio of the second cathode active material to the first cathode active material is in a range from 0.1 to 1.0.

8. The method of claim 1, further comprising:
creating a mixture including the composite cathode active material, a conductive filler, and a binder; and
applying the mixture onto a cathode current collector to form a cathode active material layer of the cathode electrode.

9. The method of claim 8, wherein the cathode active material layer comprises:
the composite cathode active material in a range from 90 wt % to 98 wt %,
a conductive filler in a range from 0.5 wt % to 10 wt %, and
a binder in a range from 0.5 wt % to 10 wt %.

10. The method of claim 1, wherein the outer layer is formed on the first cathode active material using co-precipitation.

11. The method of claim 1, wherein the outer layer is formed on the first cathode active material using spray drying.

12. The method of claim 1, wherein the outer layer is formed on the first cathode active material using dry mixing.

13. A cathode electrode, comprising:
a cathode current collector; and
a cathode active material layer including a composite cathode active material comprising a first cathode active material and an outer layer including a second cathode active material arranged on the first cathode active material,
wherein the first cathode active material comprises a lithium- and manganese-rich (LMR) cathode active material, and
the second cathode active material comprises an NMX cathode active material including lithium, and nickel (Ni) and manganese (Mn) with a molar ratio in a range from 3/7 to 8/2.

14. The cathode electrode of claim 13, wherein the first cathode active material comprises Li₁₊ₐNi_{b}Mn_{c}M_{d}O₂, where a+b+c+d=1.0, a is in a range from 0.05 to 0.3, M_{d} is a metal, b is in a range from 0.1 to 0.5, c is in a range from 0.2 to 0.8, and d is in a range from 0.01 to 0.2.

15. The cathode electrode of claim 14, wherein the metal M_{d} is selected from a group consisting of iron, titanium, cerium, tungsten, molybdenum, vanadium, zirconium, niobium, tantalum, aluminum, cobalt, and magnesium.

16. The cathode electrode of claim 13, wherein the second cathode active material comprises LiNiₓMn_{y}M_{z}O₂, where x+y+z=1.0, M_{z} is a metal, x is in a range from 0.4 to 0.8, y is in a range from 0.2 to 0.6, and z is in a range from 0.01 to 0.2.

17. The cathode electrode of claim 16, wherein the metal M_{z} is a metal selected from a group consisting of iron, tungsten, molybdenum, vanadium, zirconium, niobium, aluminum, magnesium, and tantalum.

18. The cathode electrode of claim 13, wherein a weight ratio of the second cathode active material to the first cathode active material is in a range from 0.1 to 1.0.

19. The cathode electrode of claim 13, wherein the cathode active material layer comprises:
the composite cathode active material in a range from 90 wt % to 98 wt %,
a conductive filler in a range from 0.5 wt % to 10 wt %, and
a binder in a range from 0.5 wt % to 10 wt %.

20. A battery cell comprising:
C of the cathode electrode of claim 13;
A anode electrodes; and
S separators, where C, A and S are integers greater than 1,
wherein the A anode electrodes include anode active material selected from a group consisting of Si, Si—C, SiOx, graphite, Li metal, and combinations thereof.
